(19) United States
(12) Patent Application Publication
(10) Pub. No.: US 2026/0363227 A1
(43) Pub. Date: Nov. 19, 2026

(54) DYNAMIC IRRIGATION SCHEDULING OPTIMIZING AGRICULTURAL PROFIT BY INTEGRATING SHORT-HORIZON METEOROLOGICAL FORECASTING WITH ECONOMIC MARKET DATA

(71) Applicant: Texas Tech University System, Lubbock, TX (US)

(72) Inventors: Darren Hudson, Lubbock, TX (US); Rachel Wade, Lubbock, TX (US); Syed Badruddoza, Lubbock, TX (US); Krishna SV Jagadish, Lubbock, TX (US)

(73) Assignee: Texas Tech University System, Lubbock, TX (US)

(21) Appl. No.: 19/678,319

(22) Filed: May 15, 2026

Related U.S. Application Data
(60) Provisional application No. 63/806,386, filed on May 15, 2025.

(51) Int. Cl. A01M 7/00; A01G 25/16; G06N 3/0442; G06Q 10/04; G06Q 30/0201; G06Q 50/02; G16Y 40/10

(52) U.S. Cl. CPC A01M 7/0089; A01G 25/167; G06N 3/0442; G06Q 10/04; G06Q 30/0206; G06Q 50/02; G16Y 40/10

(57) ABSTRACT

A computer-implemented method, system, and computer program product for dynamic irrigation scheduling to optimize agricultural profit. Data streams including short-horizon meteorological forecasts, soil-specific constants, and real-time economic market data, are acquired. Future soil moisture conditions over a specified short-term horizon are then predicted, using a machine-learning model, based at least in part on the short-horizon meteorological forecasts and the soil-specific constants. An economic threshold for irrigation is then determined based on a marginal return analysis of the real-time economic market data. Furthermore, a profit-maximizing irrigation volume (I*) is calculated for the specified short-term horizon by integrating the predicted future soil moisture conditions with the determined economic threshold. An irrigation event is then automatically initiated via an automated irrigation system to deliver the calculated profit-maximizing irrigation volume in response to the profit-maximizing irrigation volume exceeding an operational activation threshold value.

### TECHNICAL FIELD

The present invention relates generally to the field of precision agriculture, and more particularly to dynamic irrigation scheduling that optimizes agricultural profit by integrating short-horizon meteorological forecasting with economic market data.

### BACKGROUND

Precision agriculture has emerged as a transformative management strategy that leverages digital technologies to enhance resource use efficiency and agricultural productivity. Historically, precision agriculture has focused on addressing spatial variability (differences in soil characteristics, environmental conditions, and crop performance that occur across various physical locations within a single field) utilizing tools, such as Global Positioning Systems (GPS), geographic information systems (GIS), and variable-rate application (VRA) technologies, to apply inputs, such as seed and fertilizer, more precisely. As the agricultural industry moves toward more data-intensive operations, the focus has expanded from simple spatial precision to “smart” agriculture, which integrates real-time data streams and predictive analytics to manage temporal variability in crop needs.

Despite these advancements, a significant gap remains in how critical resources, such as water, are managed, particularly in areas facing extreme scarcity. While existing technologies excel at determining where to apply resources, traditional irrigation management typically relies on “backward-looking” methodologies to determine when or how much to irrigate. These methods often utilize historical climate data or real-time sensor measurements to maintain soil moisture at a specific threshold, regardless of the projected cost of water or the current market value of the crop. Such systems are often referred to as “irrigation triggers,” which focus solely on the agronomic needs of the plant rather than the economic viability of the farming operation.

Existing precision farming tools frequently fail to account for the diminishing marginal returns of water application. While increasing irrigation may increase crop yield, there is a point at which the cost of additional water (including pumping and labor costs) exceeds the value of the incremental yield gained. Furthermore, standard models often lack the ability to accurately predict soil moisture levels over a short-term horizon, leading to either over-irrigation, which wastes resources, or under-irrigation, which causes avoidable crop stress.

Accordingly, there is a significant and growing need for a predictive decision support system that transcends static irrigation triggers by accounting for both forecasted environmental shifts and the fluctuating economic realities of the agricultural market. Specifically, a need exists for a solution that can identify the precise volume of water required to optimize the financial return of a farming operation, rather than merely satisfying the biological requirements of the crop. Such a system needs to be capable of reconciling the cost of resource application with the projected value of incremental yields to prevent resource waste and maximize net profitability in increasingly water-scarce environments.

### SUMMARY

In one embodiment of the present disclosure, a computer-implemented method for dynamic irrigation scheduling to optimize agricultural profit comprises acquiring a plurality of data streams comprising short-horizon meteorological forecasts, soil-specific constants, and real-time economic market data. The method further comprises predicting, using a machine-learning model, future soil moisture conditions over a specified short-term horizon based at least in part on the short-horizon meteorological forecasts and the soil-specific constants. The method additionally comprises determining an economic threshold for irrigation based on a marginal return analysis of the real-time economic market data, where the real-time economic market data comprises a current market value of a crop and a projected cost of water application. Furthermore, the method comprises calculating a profit-maximizing irrigation volume for the specified short-term horizon by integrating the predicted future soil moisture conditions with the determined economic threshold. Additionally, the method comprises automatically initiating an irrigation event via an automated irrigation system to deliver the calculated profit-maximizing irrigation volume in response to the profit-maximizing irrigation volume exceeding an operational activation threshold value.

Other forms of the embodiment of the computer-implemented method described above are in a system and in a computer program product.

The foregoing has outlined rather generally the features and technical advantages of one or more embodiments of the present disclosure in order that the detailed description of the present disclosure that follows may be better understood. Additional features and advantages of the present disclosure will be described hereinafter which may form the subject of the claims of the present disclosure.

### BRIEF DESCRIPTION OF THE DRAWINGS

A better understanding of the present disclosure can be obtained when the following detailed description is considered in conjunction with the following drawings, in which:

FIG. 1 illustrates an embodiment of the present disclosure of a computing environment for practicing the principles of the present disclosure;

FIG. 2 is a diagram of the software components used by the computer to implement dynamic irrigation scheduling that optimizes agricultural profit by integrating short-horizon meteorological forecasting with economic market data in accordance with an embodiment of the present disclosure;

FIG. 3 is a flowchart of a method for implementing dynamic irrigation scheduling to optimize agricultural profit by integrating short-horizon meteorological forecasting with economic market data in accordance with an embodiment of the present disclosure;

FIG. 4 is a scatter plot illustrating the predictive accuracy of the machine-learning model in accordance with an embodiment of the present disclosure; and

FIG. 5 is a graphical representation of the economic optimization curve in accordance with an embodiment of the present disclosure.

### DETAILED DESCRIPTION

As stated above, precision agriculture has emerged as a transformative management strategy that leverages digital technologies to enhance resource use efficiency and agricultural productivity. Historically, precision agriculture has focused on addressing spatial variability (differences in soil characteristics, environmental conditions, and crop performance that occur across various physical locations within a single field) utilizing tools, such as Global Positioning Systems (GPS), geographic information systems (GIS), and variable-rate application (VRA) technologies, to apply inputs, such as seed and fertilizer, more precisely. As the agricultural industry moves toward more data-intensive operations, the focus has expanded from simple spatial precision to “smart” agriculture, which integrates real-time data streams and predictive analytics to manage temporal variability in crop needs.

Despite these advancements, a significant gap remains in how critical resources, such as water, are managed, particularly in areas facing extreme scarcity. While existing technologies excel at determining where to apply resources, traditional irrigation management typically relies on “backward-looking” methodologies to determine when or how much to irrigate. These methods often utilize historical climate data or real-time sensor measurements to maintain soil moisture at a specific threshold, regardless of the projected cost of water or the current market value of the crop. Such systems are often referred to as “irrigation triggers,” which focus solely on the agronomic needs of the plant rather than the economic viability of the farming operation.

Existing precision farming tools frequently fail to account for the diminishing marginal returns of water application. While increasing irrigation may increase crop yield, there is a point at which the cost of additional water (including pumping and labor costs) exceeds the value of the incremental yield gained. Furthermore, standard models often lack the ability to accurately predict soil moisture levels over a short-term horizon and fail to customize irrigation recommendations to field-specific agronomic and economic conditions, leading to either over-irrigation, which wastes resources, or under-irrigation, which causes avoidable crop stress.

Accordingly, there is a significant and growing need for a predictive decision support system that transcends static irrigation triggers by accounting for both forecasted environmental shifts and the fluctuating economic realities of the agricultural market. Specifically, a need exists for a solution that can identify the precise volume of water required to optimize the financial return of a farming operation, rather than merely satisfying the biological requirements of the crop. Such a system needs to be capable of reconciling the cost of resource application with the projected value of incremental yields to prevent resource waste and maximize net profitability in increasingly water-scarce environments.

The embodiments of the present disclosure provide a means for optimizing agricultural resource allocation through a forward-looking, economically-driven decision support framework automatically tailored to changing conditions and different areas of the field that bridges the gap between agronomic necessity and financial profitability. By utilizing a multi-stage machine-learning pipeline, the embodiments of the present disclosure provide high-fidelity, short-term soil moisture predictions that account for both localized soil-specific constants and real-time atmospheric variability. Unlike traditional “irrigation triggers” that rely on backward-looking historical data or static moisture thresholds, the embodiments of the present disclosure integrate real-time economic data streams, such as crop market values and energy-dependent pumping costs, to perform a marginal return analysis. This analysis ensures that irrigation events are only initiated when the projected value of the incremental crop yield exceeds the cost of the water application, thereby maximizing the net return for the producer.

Furthermore, embodiments of the present disclosure provide a robust optimization engine that calculates a profit-maximizing irrigation volume (I*) tailored to a specific short-term horizon. A profit-maximizing irrigation volume (I*), as used herein, refers to a dynamically calculated quantity of water that represents the optimal intersection where the marginal cost of irrigation equals the marginal value of the projected crop yield. The marginal return analysis, as used herein, refers to a computational process of evaluating the economic utility of an additional unit of water input by comparing the cost of that input against the forecasted financial gain derived from improved soil moisture conditions. In one embodiment, the system utilizes a gradient-boosted regression tree or similar machine-learning model to generate conditional soil moisture forecasts. A conditional soil moisture forecast, as used herein, refers to a predictive data set that simulates future soil moisture states across a plurality of different irrigation scenarios to identify the scenario that yields the highest economic efficiency.

In one embodiment, the decision support system continuously monitors diverse data streams, including short-horizon meteorological forecasts and soil-specific constants, to refine its predictive accuracy. Short-horizon meteorological forecasts, as used herein, refer to localized, high-resolution weather data covering a period (e.g., 24 to 72 hours) that is sufficiently brief to allow for actionable irrigation adjustments before significant crop stress or resource waste occurs. Soil-specific constants, as used herein, refer to the inherent physical properties of a specific field's soil, including field capacity, wilting point, and hydraulic conductivity, which serve as fixed inputs to the machine-learning model to calibrate moisture depletion rates. By combining real-time economic thresholds with advanced predictive analytics, embodiments of the present disclosure provide a scalable and autonomous solution for modern precision agriculture. This adaptability ensures that irrigation is managed as a financial investment rather than a purely biological requirement, significantly enhancing resource use efficiency in water-scarce regions. A further description of these and other features will be provided below.

In sone embodiment of the present disclosure, the present disclosure comprises a computer-implemented method, system, and computer program product for dynamic irrigation scheduling to optimize agricultural profit. In one embodiment of the present disclosure, data streams including short-horizon meteorological forecasts, soil-specific constants, and real-time economic market data, are acquired. Short-horizon meteorological forecasts, as used herein, refer to localized, high-resolution atmospheric predictions, including precipitation probability and temperature, that allow the system to anticipate moisture depletion over a defined upcoming interval. Soil-specific constants, as used herein, refer to the static physical properties of the subject field, such as field capacity and wilting point, which define the mechanical constraints of the soil moisture prediction module. Furthermore, real-time economic market data, as used herein, refers to current crop yield values and utility-dependent irrigation costs, such as electricity or water rates, which are required to evaluate the financial viability of an irrigation event.

Future soil moisture conditions over a specified short-term horizon are then predicted, using a machine-learning model, based at least in part on the short-horizon meteorological forecasts and the soil-specific constants. Future soil moisture conditions, as used herein, refer to the projected volumetric water content and hydraulic state of the soil profile at discrete intervals within a predictive window. Furthermore, a short-term horizon, as used herein, refers to a discrete future window, typically spanning 24 to 72 hours, which provides a sufficient lead time for the system to execute proactive irrigation adjustments based on forecasted atmospheric demand. In one embodiment, the future soil moisture conditions are predicted over a specified short-term horizon by inputting the normalized data streams, specifically the atmospheric variables and soil-specific constants, into a trained machine-learning model, such as an extra trees regressor or a Long Short-Term Memory (LSTM) neural network. In one embodiment, the model is configured to map complex non-linear relationships between variables, such as solar radiation, wind speed, and precipitation, and the resulting depletion rate of water within the soil.

An economic threshold for irrigation is then determined based on a marginal return analysis of the real-time economic market data. An economic threshold, as used herein, refers to a dynamic financial limit where the cost of an incremental unit of water is exactly balanced by the value of the projected increase in crop yield derived from that water. Furthermore, a marginal return analysis, as used herein, refers to the iterative calculation of the change in total revenue resulting from an additional unit of irrigation input relative to the change in total variable cost. In one embodiment, the economic threshold for irrigation is determined by calculating the total irrigation cost and the total crop yield value across a range of potential irrigation levels.

Furthermore, a profit-maximizing irrigation volume (I*) is calculated for the specified short-term horizon by integrating the predicted future soil moisture conditions with the determined economic threshold. A profit-maximizing irrigation volume, as used herein, refers to the specific quantity of water to be applied to a field that satisfies the dual constraints of maintaining soil moisture above a critical crop-stress threshold while ensuring that the cost of that water does not exceed the marginal increase in projected yield value. In one embodiment, the profit-maximizing irrigation volume (I*) is calculated for the specified short-term horizon by performing a multi-objective optimization that filters the generated conditional soil moisture forecasts against the identified economic threshold.

An irrigation event is then automatically initiated via an automated irrigation system to deliver the calculated profit-maximizing irrigation volume in response to the profit-maximizing irrigation volume exceeding an operational activation threshold value. An irrigation event, as used herein, refers to the physical application of a specific volume of water to a target area over a scheduled duration as governed by the optimized irrigation command. An operational activation threshold value, as used herein, refers to a minimum quantity of water required to justify the operational “start-up” costs of the irrigation infrastructure, such as the energy surge required to prime pumps or the labor involved in manual valve adjustments. In one embodiment, the irrigation event is initiated via the actuation of the irrigation infrastructure. In one embodiment, the irrigation infrastructure is actuated by transmitting electronic control signals via a communication fabric to field actuators, such as solenoid valves, variable frequency drives (VFDs) on pump motors, or center-pivot drive systems. By translating the optimized digital instruction set into physical mechanical actions, it is ensured that the precisely calculated volume of water is delivered to the field at the optimized time.

In this manner, agricultural resource allocation is optimized by implementing dynamic irrigation scheduling that optimizes agricultural profit by integrating short-horizon meteorological forecasting with economic market data.

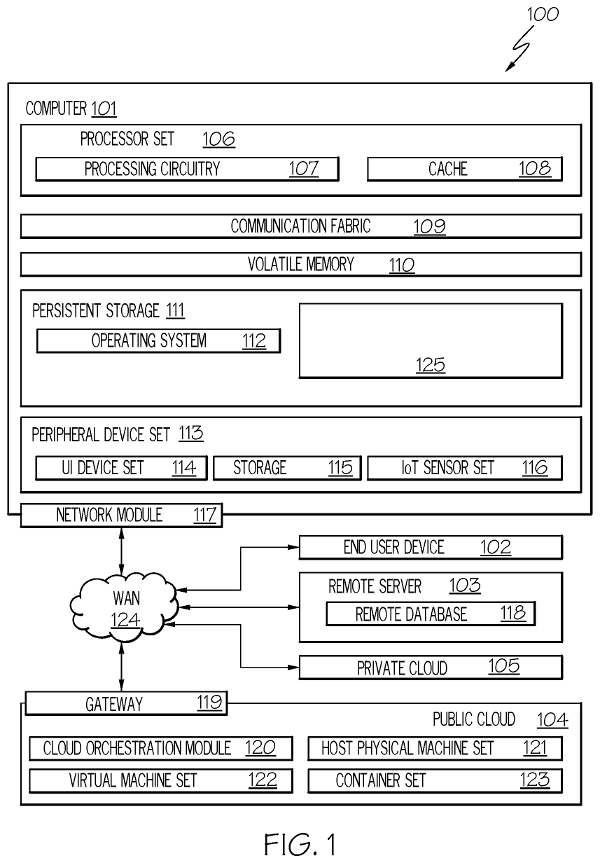

Referring now to the Figures in detail, FIG. 1 illustrates an embodiment of the present disclosure of a computing environment 100 for practicing the principles of the present disclosure.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 100 contains an example of an environment for the execution of at least some of the computer code (stored in block 125) involved in performing the inventive methods, such as implementing dynamic irrigation scheduling that optimizes agricultural profit by integrating short-horizon meteorological forecasting with economic market data. In addition to block 125, computing environment 100 includes, for example, computer 101 (also referred to herein as computing device 101), network 124, such as a wide area network (WAN), end user device (EUD) 102, remote server 103, public cloud 104, and private cloud 105. In this embodiment, computer 101 includes processor set 106 (including processing circuitry 107 and cache 108), communication fabric 109, volatile memory 110, persistent storage 111 (including operating system 112 and block 125, as identified above), peripheral device set 113 (including user interface (UI) device set 114, storage 115, and Internet of Things (IoT) sensor set 116), and network module 117. Remote server 103 includes remote database 118. Public cloud 104 includes gateway 119, cloud orchestration module 120, host physical machine set 121, virtual machine set 122, and container set 123.

Computer 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 118. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

Processor set 106 includes one, or more, computer processors of any type now known or to be developed in the future. Processing circuitry 107 may be distributed over multiple packages, for example, multiple, coordinated integrated circuit chips. Processing circuitry 107 may implement multiple processor threads and/or multiple processor cores. Cache 108 is memory that is located in the processor chip package(s) and is typically used for data or code that should be available for rapid access by the threads or cores running on processor set 106. Cache memories are typically organized into multiple levels depending upon relative proximity to the processing circuitry. Alternatively, some, or all, of the cache for the processor set may be located “off chip.” In some computing environments, processor set 106 may be designed for working with qubits and performing quantum computing.

Computer readable program instructions are typically loaded onto computer 101 to cause a series of operational steps to be performed by processor set 106 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 108 and the other storage media discussed below. The program instructions, and associated data, are accessed by processor set 106 to control and direct performance of the inventive methods. In computing environment 100, at least some of the instructions for performing the inventive methods may be stored in block 125 in persistent storage 111.

Communication fabric 109 is the signal conduction paths that allow the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

Volatile memory 110 is any type of volatile memory now known or to be developed in the future. Examples include dynamic type random access memory (RAM) or static type RAM. Typically, the volatile memory is characterized by random access, but this is not required unless affirmatively indicated. In computer 101, the volatile memory 110 is located in a single package and is internal to computer 101, but, alternatively or additionally, the volatile memory may be distributed over multiple packages and/or located externally with respect to computer 101.

Persistent Storage 111 is any form of non-volatile storage for computers that is now known or to be developed in the future. The non-volatility of this storage means that the stored data is maintained regardless of whether power is being supplied to computer 101 and/or directly to persistent storage 111. Persistent storage 111 may be a read only memory (ROM), but typically at least a portion of the persistent storage allows writing of data, deletion of data and re-writing of data. Some familiar forms of persistent storage include magnetic disks and solid state storage devices. Operating system 112 may take several forms, such as various known proprietary operating systems or open source Portable Operating System Interface type operating systems that employ a kernel. The code included in block 125 typically includes at least some of the computer code involved in performing the inventive methods.

Peripheral device set 113 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion type connections (for example, secure digital (SD) card), connections made though local area communication networks and even connections made through wide area networks such as the internet. In various embodiments, UI device set 114 may include components such as a display screen, speaker, microphone, wearable devices (such as goggles and smart watches), keyboard, mouse, printer, touchpad, game controllers, and haptic devices. Storage 115 is external storage, such as an external hard drive, or insertable storage, such as an SD card. Storage 115 may be persistent and/or volatile. In some embodiments, storage 115 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 116 is made up of sensors that can be used in Internet of Things applications. For example, one sensor may be a thermometer and another sensor may be a motion detector.

Network module 117 is the collection of computer software, hardware, and firmware that allows computer 101 to communicate with other computers through WAN 124. Network module 117 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 117 are performed on the same physical hardware device. In other embodiments (for example, embodiments that utilize software-defined networking (SDN)), the control functions and the forwarding functions of network module 117 are performed on physically separate devices, such that the control functions manage several different network hardware devices. Computer readable program instructions for performing the inventive methods can typically be downloaded to computer 101 from an external computer or external storage device through a network adapter card or network interface included in network module 117.

WAN 124 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End user device (EUD) 102 is any computer system that is used and controlled by an end user (for example, a customer of an enterprise that operates computer 101), and may take any of the forms discussed above in connection with computer 101. EUD 102 typically receives helpful and useful data from the operations of computer 101. For example, in a hypothetical case where computer 101 is designed to provide a recommendation to an end user, this recommendation would typically be communicated from network module 117 of computer 101 through WAN 124 to EUD 102. In this way, EUD 102 can display, or otherwise present, the recommendation to an end user. In some embodiments, EUD 102 may be a client device, such as thin client, heavy client, mainframe computer, desktop computer and so on.

Remote server 103 is any computer system that serves at least some data and/or functionality to computer 101. Remote server 103 may be controlled and used by the same entity that operates computer 101. Remote server 103 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 118 of remote server 103.

Public cloud 104 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 104 is performed by the computer hardware and/or software of cloud orchestration module 120. The computing resources provided by public cloud 104 are typically implemented by virtual computing environments that run on various computers making up the computers of host physical machine set 121, which is the universe of physical computers in and/or available to public cloud 104. The virtual computing environments (VCEs) typically take the form of virtual machines from virtual machine set 122 and/or containers from container set 123. It is understood that these VCEs may be stored as images and may be transferred among and between the various physical machine hosts, either as images or after instantiation of the VCE. Cloud orchestration module 120 manages the transfer and storage of images, deploys new instantiations of VCEs and manages active instantiations of VCE deployments. Gateway 119 is the collection of computer software, hardware, and firmware that allows public cloud 104 to communicate through WAN 124.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 105 is similar to public cloud 104, except that the computing resources are only available for use by a single enterprise. While private cloud 105 is depicted as being in communication with WAN 124 in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 104 and private cloud 105 are both part of a larger hybrid cloud.

Block 125 further includes the software components which are used to implement dynamic irrigation scheduling that optimizes agricultural profit by integrating short-horizon meteorological forecasting with economic market data. In one embodiment, such components may be implemented in hardware. The functions discussed above performed by such components are not generic computer functions. As a result, computer 101 is a particular machine that is the result of implementing specific, non-generic computer functions.

In one embodiment, the functionality of such software components of computer 101, including the functionality for implementing dynamic irrigation scheduling that optimizes agricultural profit by integrating short-horizon meteorological forecasting with economic market data, may be embodied in an application specific integrated circuit.

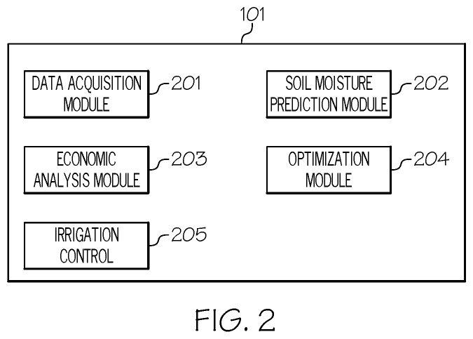

A further discussion regarding the functionality of the components used by computer 101 to implement dynamic irrigation scheduling that optimizes agricultural profit by integrating short-horizon meteorological forecasting with economic market data is provided below in connection with FIG. 2.

FIG. 2 is a diagram of the software components used by computer 101 to implement dynamic irrigation scheduling that optimizes agricultural profit by integrating short-horizon meteorological forecasting with economic market data in accordance with an embodiment of the present disclosure.

Referring to FIG. 2, in conjunction with FIG. 1, computer 101 includes data acquisition module 201. In one embodiment, data acquisition module 201 is configured to aggregate and preprocess disparate data streams from a plurality of local and remote sources to facilitate predictive soil moisture modeling and economic optimization. A data stream, as used herein, refers to a continuous or periodic transmission of digital information, such as atmospheric observations, soil sensor telemetry, or market price feeds, that provides the raw input parameters required for the marginal return analysis. Data acquisition module 201 serves as the primary ingestion interface for the system, managing the retrieval of short-horizon meteorological forecasts, soil-specific constants, and real-time economic market data.

Short-horizon meteorological forecasts, as used herein, refer to localized, high-resolution atmospheric predictions, including precipitation probability and temperature, that allow the system to anticipate moisture depletion over a defined upcoming interval. Soil-specific constants, as used herein, refer to the static physical properties of the subject field, such as field capacity and wilting point, which define the mechanical constraints of soil moisture prediction module 202 (discussed further below). By synthesizing these environmental inputs with real-time economic market data, such as current crop yield values and utility-dependent irrigation costs, data acquisition module 201 enables the system to evaluate the financial viability of a potential irrigation event.

In some embodiments, data acquisition module 201 is further configured to normalize these data streams into a standardized format suitable for ingestion by a machine-learning model. For example, the module may interface with IoT sensor set 116 via network module 117 to obtain current volumetric water content while simultaneously querying remote agricultural databases, such as those maintained by the USDA National Agricultural Statistics Service (NASS), for updated commodity pricing. This comprehensive data aggregation ensures that optimization module 204 (discussed further below) can accurately calculate the profit-maximizing irrigation volume (I*), which represents the optimal intersection where the marginal cost of irrigation equals the marginal value of the projected crop yield, based on the most current environmental and economic conditions.

Computer 101 further includes soil moisture prediction module 202. In one embodiment, soil moisture prediction module 202 is configured to process the normalized data streams provided by data acquisition module 201 to generate a high-fidelity prediction of future soil states over a specified short-term horizon. A short-term horizon, as used herein, refers to a discrete future window, typically spanning 24 to 72 hours, which provides a sufficient lead time for the system to execute proactive irrigation adjustments based on forecasted atmospheric demand. In one embodiment, soil moisture prediction module 202 utilizes a trained machine-learning model, such as an extra trees regressor or a Long Short-Term Memory (LSTM) neural network, to map complex non-linear relationships between meteorological variables and the depletion rate of volumetric water content within a specific soil profile. In one embodiment, the extra trees regressor is utilized to prioritize computational efficiency, while the LSTM neural network is utilized to capture long-range temporal dependencies in sequential sensor data.

In one embodiment, the machine-learning model utilizes the LSTM neural network to process temporal variability in the short-horizon meteorological forecasts. Temporal variability, as used herein, refers to the fluctuations in environmental conditions, atmospheric demand, and market-driven economic factors that occur over a defined period of time. By accounting for these time-based shifts, such as changing precipitation probabilities or volatile utility costs, the system ensures that irrigation commands remain optimized for the specific conditions of the upcoming short-term horizon.

In one embodiment, soil moisture prediction module 202 generates a conditional soil moisture forecast. A conditional soil moisture forecast, as used herein, refers to a set of predictive outcomes that simulate how soil moisture will evolve under various hypothetical irrigation scenarios, ranging from zero application to full field capacity. By evaluating these scenarios against soil-specific constants, such as hydraulic conductivity and initial moisture levels, soil moisture prediction module 202 provides optimization module 204 (discussed further below) with a probabilistic map of how different water volumes will impact the plant's agronomic state. As discussed further below herein, the predictive accuracy of the model is characterized by a strong correlation between predicted and actual moisture values, ensuring that the resulting forecasts provide a reliable foundation for economic decision-making. The predictive accuracy, as used herein, refers to the statistical proximity of the forecasted volumetric water content to the actual ground-truth measurements obtained by physical sensors.

Furthermore, in some embodiments, soil moisture prediction module 202 is configured to implement a recursive feedback loop that incorporates real-time telemetry from IoT sensor set 116 to minimize model drift. A recursive feedback loop, as used herein, refers to a process where the difference between a previously predicted moisture level and the actual moisture level measured by a physical sensor is used to recalibrate the machine-learning model's weights for subsequent intervals. This continuous calibration ensures that soil moisture prediction module 202 maintains high precision across varying crop growth stages and unpredictable local weather shifts, effectively reducing the root mean square error (RMSE) of the model over time, thereby preventing the over-irrigation or under-irrigation errors common in traditional threshold-based systems.

Computer 101 additionally includes economic analysis module 203. In one embodiment, economic analysis module 203 is configured to determine an economic threshold for irrigation by performing a marginal return analysis on the real-time economic market data retrieved by data acquisition module 201. An economic threshold, as used herein, refers to a dynamic financial limit where the cost of an incremental unit of water is exactly balanced by the value of the projected increase in crop yield derived from that water. This component serves as the financial “governor” of the system, shifting the irrigation logic from a purely biological requirement to a value-based investment strategy. In one embodiment, this shift is implemented by establishing a logical gate that prevents the initiation of an irrigation event unless the marginal return analysis indicates a positive net profit. Marginal return analysis, as used herein, is a dynamic financial calculation that identifies the optimal irrigation volume by determining the precise intersection where the cost of an incremental unit of water equals the market value of the resulting incremental increase in crop yield.

In one embodiment, economic analysis module 203 calculates the marginal cost of irrigation and the marginal value of yield. The marginal cost of irrigation, as used herein, refers to the total variable expense associated with delivering an additional volume of water to the field, including utility-dependent pumping costs, labor, and water-right fees. The marginal value of yield, as used herein, refers to the expected increase in gross revenue, which can be calibrated against current market commodity prices, resulting from the improved soil moisture states predicted by soil moisture prediction module 202. By analyzing these variables, economic analysis module 203 identifies the point of diminishing returns where further irrigation would result in a net financial loss, regardless of whether the plant could agronomically absorb more water. As discussed further below herein, this point is represented by the peak of the net profit curve, where the slope of the crop yield value curve begins to be outpaced by the slope of the irrigation cost curve.

Furthermore, in some embodiments, economic analysis module 203 is configured to adapt the economic threshold based on real-time market volatility or resource scarcity. For example, if energy prices for pumping increase or if the market value of the crop fluctuates, the module dynamically adjusts the threshold to ensure that the profit-maximizing irrigation volume (I*) remains aligned with the producer's current financial objectives. This continuous economic recalibration ensures that the system proactively mitigates the risk of over-investing in water resources during periods of low crop value or high operational cost, such as when peak-hour energy surcharges for pumping exceed the localized market value of the crop, thereby optimizing the overall net return for the farming operation.

Furthermore, computer 101 includes optimization module 204. In one embodiment, optimization module 204 is configured to synthesize the predictive outputs from soil moisture prediction module 202 with the financial constraints established by economic analysis module 203 to generate an optimized irrigation command. An optimized irrigation command, as used herein, refers to a digital instruction set, which is transmittable via WAN 124, that specifies the precise timing and volume of water to be applied to a field to maximize net profitability. In one embodiment, optimization module 204 acts as the central decision-making core of the system, reconciling the physical water needs of the crop with the economic realities of the market.

In one embodiment, optimization module 204 executes a multi-variable objective function to determine the profit-maximizing irrigation volume (I*). The multi-variable objective function, as used herein, refers to a mathematical optimization algorithm that treats soil moisture depletion as a cost-variable and crop yield preservation as a value-variable. By iterating through the various scenarios provided in the conditional soil moisture forecast, optimization module 204 identifies the specific irrigation volume where the projected marginal revenue is maximized relative to the total operational cost. In some embodiments, optimization module 204 utilizes a gradient-based search or a genetic algorithm to converge on the I* value within the high-resolution scenario map. This ensures that the system does not merely target a static moisture “set-point,” but rather finds the fluid equilibrium that yields the highest financial return for the producer.

Furthermore, in some embodiments, optimization module 204 is configured to translate the calculated I* into a sequence of operational control signals for the irrigation infrastructure. The irrigation infrastructure, as used herein, represents the physical hardware layer that executes the digital instructions generated by optimization module 204. In one embodiment, the irrigation infrastructure consists of the field-level mechanical systems responsible for the actual delivery of water to the crop.

Depending on the specific embodiment of the field setup, this irrigation infrastructure typically includes the following components: (1) actuators and automated valves, (2) pumping stations, (3) distribution systems, and (4) localized controllers. The actuators and automated valves are the electromechanical devices that receive signals from network module 117 to physically open or close water flow to specific sections of the field. In some embodiments, these components are addressed individually by optimization module 204 to allow for variable rate irrigation (VRI) across different zones of a single field. The pumping stations include the motors and pumps required to extract water from a source (such as a well or reservoir) and pressurize the distribution system. The distribution systems refer to the physical method of water delivery, which may take the form of a center-pivot system, drip irrigation lines, or lateral move systems. The localized controllers refer to the on-site Programmable Logic Controller (PLC) or a similar interface that acts as a bridge between WAN 124 and the high-voltage hardware of the pumps and valves.

In one embodiment, optimization module 204 may determine that while the plant requires a specific volume of water, the irrigation event should be delayed to coincide with lower utility rate windows identified by economic analysis module 203. By issuing these signals through network module 117, optimization module 204 can remotely trigger physical valves, pumps, or pivot systems. By optimizing the duty cycle of these physical components, the system further reduces mechanical wear and tear, providing a secondary economic benefit beyond water savings. By dynamically scheduling these events, optimization module 204 provides an automated, “set-and-forget” management layer that maintains the field within a high-profit envelope while minimizing the manual oversight required by the user.

Additionally, computer 101 includes irrigation control 205. In one embodiment, irrigation control 205 is configured to function as the operational execution layer that receives the optimized irrigation command from optimization module 204 and converts it into a series of low-level machine instructions. In one embodiment, irrigation control 205 acts as the software-to-hardware bridge, ensuring that the high-level economic and agronomic decisions are accurately mapped to the specific mechanical capabilities and hydraulic constraints of the irrigation infrastructure.

In one embodiment, irrigation control 205 manages temporal scheduling and zonal distribution logic. Temporal scheduling, as used herein, refers to the precise timing of valve actuation and pump cycling to ensure that water delivery aligns with the utility-dependent cost windows identified during the marginal return analysis. Zonal distribution logic, as used herein, refers to the spatial management of the field, allowing the system to direct different volumes of water to discrete sections of the field based on localized soil moisture variances detected by IoT sensor set 116. By managing these variables, irrigation control 205 ensures that the physical application of water precisely matches the profit-maximizing irrigation volume (I*) calculated by the system.

Furthermore, in some embodiments, irrigation control 205 is configured to perform system health monitoring and safety overrides. For example, irrigation control 205 may monitor feedback signals from the localized controllers of the irrigation infrastructure to detect mechanical failures, such as pipe bursts or pump malfunctions. In the event of a detected anomaly, irrigation control 205 can execute an emergency shutdown command and transmit a corresponding alert to end user device (EUD) 102 via network 124 to prevent resource waste or equipment damage, regardless of the current optimized schedule. This integrated monitoring ensures that the automation provided by optimization module 204 remains within safe operating parameters, providing a robust and reliable management layer for the farming operation.

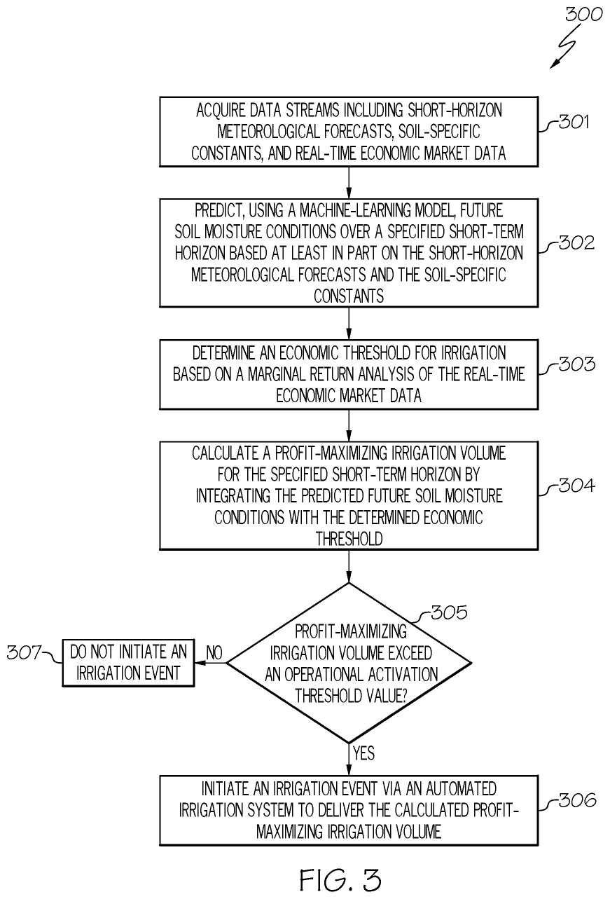

A discussion regarding the method for implementing dynamic irrigation scheduling to optimize agricultural profit by integrating short-horizon meteorological forecasting with economic market data using the software components discussed above is provided below in connection with FIG. 3.

FIG. 3 is a flowchart of a method 300 for implementing dynamic irrigation scheduling to optimize agricultural profit by integrating short-horizon meteorological forecasting with economic market data in accordance with an embodiment of the present disclosure.

Referring to FIG. 3, in conjunction with FIGS. 1-2, in step 301, data acquisition module 201 acquires data streams including short-horizon meteorological forecasts, soil-specific constants, and real-time economic market data. As discussed above, short-horizon meteorological forecasts refer to localized, high-resolution atmospheric predictions, including precipitation probability and temperature, that allow the system to anticipate moisture depletion over a defined upcoming interval. As also discussed above, soil-specific constants, as used herein, refer to the static physical properties of the subject field, such as field capacity and wilting point, which define the mechanical constraints of soil moisture prediction module 202. Furthermore, real-time economic market data, as used herein, refers to current crop yield values and utility-dependent irrigation costs, such as electricity or water rates, which are required to evaluate the financial viability of an irrigation event.

In one embodiment, data acquisition module 201 acquires data streams by establishing a plurality of network connections through network module 117 and WAN 124 to query remote servers 103 and external agricultural or meteorological databases (e.g., remote databases 118). For example, data acquisition module 201 may utilize application programming interfaces (APIs) to pull hourly weather updates and real-time economic market data, such as real-time commodity pricing, from the USDA National Agricultural Statistics Service (NASS) or similar entities. Simultaneously, data acquisition module 201 may interface with IoT sensor set 116 via communication fabric 109 to ingest local telemetry, such as current volumetric water content and ambient ground temperature.

In one embodiment, data acquisition module 201 implements a preprocessing phase where the acquired data streams are normalized into a standardized digital format. This preprocessing may include noise reduction, outlier removal from sensor telemetry, and the temporal alignment of disparate data feeds to ensure that meteorological forecasts and soil moisture readings are synchronized across the same short-term horizon. By aggregating these multidimensional data points into a unified data structure stored within volatile memory 110 or persistent storage 111, the necessary evidentiary foundation is provided for the system to perform high-fidelity soil moisture predictions and marginal return analysis.

In step 302, soil moisture prediction module 202 predicts, using a machine-learning model, future soil moisture conditions over a specified short-term horizon based at least in part on the short-horizon meteorological forecasts and the soil-specific constants. Future soil moisture conditions, as used herein, refer to the projected volumetric water content and hydraulic state of the soil profile at discrete intervals within a predictive window. Furthermore, as discussed above, a short-term horizon, as used herein, refers to a discrete future window, typically spanning 24 to 72 hours, which provides a sufficient lead time for the system to execute proactive irrigation adjustments based on forecasted atmospheric demand.

In one embodiment, soil moisture prediction module 202 predicts, using a machine-learning model, future soil moisture conditions over a specified short-term horizon by inputting the normalized data streams, specifically the atmospheric variables and soil-specific constants, into a trained machine-learning model, such as an extra trees regressor or a Long Short-Term Memory (LSTM) neural network. In one embodiment, the model is configured to map complex non-linear relationships between variables, such as solar radiation, wind speed, and precipitation, and the resulting depletion rate of water within the soil. To ensure high-fidelity outcomes, soil moisture prediction module 202 generates a conditional soil moisture forecast, which simulates how these future soil moisture conditions will evolve under multiple hypothetical irrigation scenarios, ranging from no water application to an application reaching full field capacity.

In one embodiment, the machine-learning model utilizes the LSTM neural network to process temporal variability in the short-horizon meteorological forecasts. Temporal variability, as used herein, refers to the fluctuations in environmental conditions, atmospheric demand, and market-driven economic factors that occur over a defined period of time. By accounting for these time-based shifts, such as changing precipitation probabilities or volatile utility costs, the system ensures that irrigation commands remain optimized for the specific conditions of the upcoming short-term horizon.

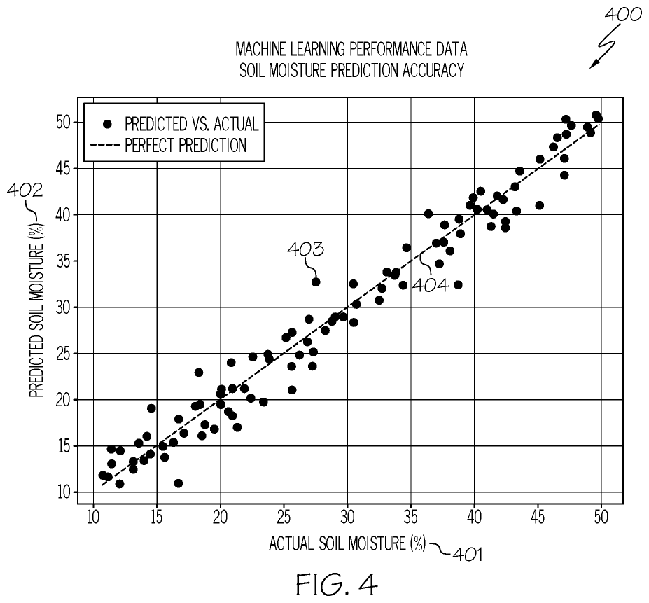

In one embodiment, soil moisture prediction module 202 includes a recursive feedback loop to achieve the accuracy required for economic optimization. In one embodiment, soil moisture prediction module 202 retrieves the real-time ground-truth telemetry from IoT sensor set 116 and calculates the error between the predicted future soil moisture conditions and the real-time ground truth telemetry. The machine-learning model's weights are then recalibrated for subsequent intervals based on the calculated error to minimize model drift and account for localized environmental shifts. As illustrated in FIG. 4, this continuous calibration provides a reliable foundation for the system to maintain high precision across varying crop growth stages.

FIG. 4 is a scatter plot 400 illustrating the predictive accuracy of the machine-learning model in accordance with an embodiment of the present disclosure. Scatter plot 400 includes an x-axis 401 representing the actual (measured) volumetric water content (%) (i.e., actual soil moisture (%)) and a y-axis 402 representing the predicted volumetric water content (%) (i.e., predicted soil moisture (%)). A plurality of data points 403 are distributed across the plot, where each data point represents a specific prediction event compared against ground-truth telemetry from IoT sensor set 116.

In one embodiment, scatter plot 400 includes a perfect prediction line 404 (also referred to as a unity line or 1:1 line), which represents a theoretical state of perfect predictive accuracy where the predicted value exactly matches the measured value. The tight clustering of data points 403 around perfect prediction line 404 demonstrates a high correlation coefficient, indicating that the machine-learning model successfully accounts for the non-linear variables acquired in step 301. Furthermore, the lack of significant outliers in scatter plot 400 illustrates the efficacy of the recursive feedback loop in minimizing model drift, ensuring that the multidimensional predictive map generated in step 302 provides a statistically reliable foundation for the subsequent economic optimization performed by optimization module 204.

Returning to FIG. 3, in conjunction with FIGS. 1-2 and 4, the output of soil moisture prediction module 202 is a multidimensional predictive map of future soil states, which is utilized by optimization module 204 to identify the most profitable irrigation path.

In step 303, economic analysis module 203 determines an economic threshold for irrigation based on a marginal return analysis of the real-time economic market data. As discussed above, an economic threshold, as used herein, refers to a dynamic financial limit where the cost of an incremental unit of water is exactly balanced by the value of the projected increase in crop yield derived from that water. Furthermore, as discussed above, a marginal return analysis, as used herein, refers to the iterative calculation of the change in total revenue resulting from an additional unit of irrigation input relative to the change in total variable cost.

In one embodiment, economic analysis module 203 determines an economic threshold for irrigation by calculating the total irrigation cost and the total crop yield value across a range of potential irrigation levels. Economic analysis module 203 retrieves utility-dependent pumping costs from the data stream of step 301 to establish the cost curve, while applying current commodity prices to the moisture states predicted in step 302 to quantify projected gross revenue. By identifying the moisture level where the difference between these two variables is maximized, step 303 identifies the point of diminishing returns where further irrigation would result in a net financial loss, regardless of agronomic absorption capacity

In one embodiment, economic analysis module 203 determines the economic threshold by calculating the diminishing marginal returns of yield relative to an incremental water application. Marginal returns, as used herein, refer to the additional revenue generated from the incremental increase in crop yield produced by the application of one additional unit of water, less the cost of acquiring and applying that unit of water.

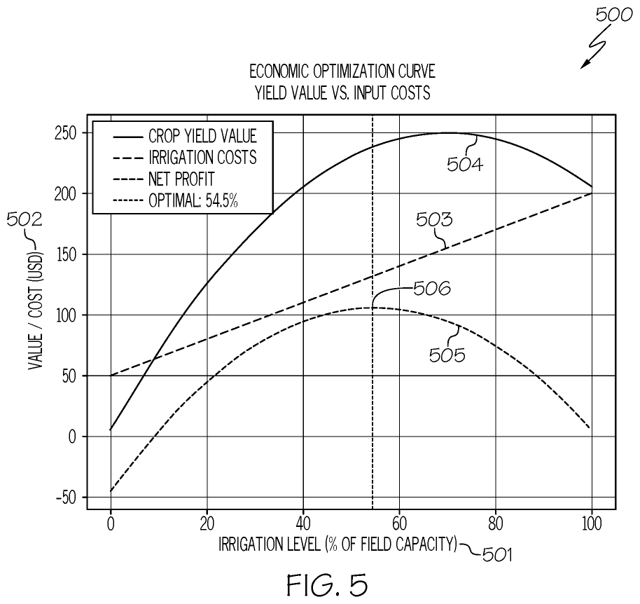

Furthermore, economic analysis module 203 performs such a calculation by performing a marginal analysis where economic analysis module 203 identifies the optimal irrigation volume (I*). This is achieved by determining the point where the marginal cost (MC), which includes pumping energy, labor, and water utility rates, is equal to the marginal value (MV) of the projected yield increase. As illustrated in FIG. 5 (discussed further below), as the soil moisture reaches saturation, the incremental yield gains (the “marginal product”) typically decrease. In one embodiment, economic analysis module 203 is configured to terminate the irrigation command at the precise intersection where MV=MC, thereby ensuring that any further application of water would result in a negative net return, even if that water would have otherwise increased the physical volume of the harvest.

In one embodiment, economic analysis module 203 implements an adaptation phase where the economic threshold is recalibrated in response to real-time market volatility or resource scarcity. For example, if the energy prices for pumping increase or if the market value of the crop fluctuates, economic analysis module 203 dynamically adjusts the threshold to ensure that the profit-maximizing irrigation volume (I*) remains aligned with the producer's current financial objectives. This continuous economic recalibration ensures that the system proactively mitigates the risk of over-investing in water resources during periods of low crop value or high operational cost. As illustrated in FIG. 5, this threshold serves as a logical constraint that is digitally passed to optimization module 204 to identify a subset of viable irrigation scenarios from the predictive scenarios generated in the previous step.

FIG. 5 is a graphical representation 500 of the economic optimization curve in accordance with an embodiment of the present disclosure. Graphical representation 500 includes an x-axis 501 representing the irrigation level (as a percentage of field capacity) and a y-axis 502 representing value/cost in currency units (e.g., USD).

Within graphical representation 500, a total irrigation cost curve 503 illustrates the cumulative expense of applying water at increasing levels of field capacity. A crop yield value curve 504 illustrates the projected gross financial return based on the moisture-driven yield preservation identified in step 302.

Graphical representation 500 further includes a net profit curve 505, which represents the difference between the crop yield value curve 504 and the total irrigation cost curve 503. The economic threshold 506 (also referred to as the optimal point) is identified by the peak of the net profit curve 505.

By identifying the irrigation level that corresponds to the economic threshold 506, optimization module 204 establishes a definitive financial constraint used to generate the optimized irrigation command for the irrigation infrastructure. This ensures that the system targets the “economic sweet spot” where the producer realizes the highest possible financial return rather than simply maximizing crop growth or minimizing water use in isolation.

As illustrated in FIG. 5, the economic threshold 506 occurs at a specific profit-maximizing irrigation volume (I*) (e.g., approximately 54.5% of field capacity in this example). Any irrigation volume applied beyond this point would result in a marginal cost that exceeds the marginal gain in yield value, causing the net profit curve 505 to decline. Consequently, economic threshold 506 serves as a logical constraint that optimization module 204 uses to filter the predictive scenarios generated in step 302 to identify the most financially viable irrigation path.

Returning to FIG. 3, in conjunction with FIGS. 1-2 and 4-5, in step 304, optimization module 204 calculates a profit-maximizing irrigation volume (I*) for the specified short-term horizon by integrating the predicted future soil moisture conditions with the determined economic threshold. A profit-maximizing irrigation volume, as used herein, refers to the specific quantity of water to be applied to a field that satisfies the dual constraints of maintaining soil moisture above a critical crop-stress threshold while ensuring that the cost of that water does not exceed the marginal increase in projected yield value.

In one embodiment, optimization module 204 calculates the profit-maximizing irrigation volume (I*) for the specified short-term horizon by performing a multi-objective optimization that filters the conditional soil moisture forecasts generated in step 302 against the economic threshold 506 identified in step 303. For example, optimization module 204 evaluates various irrigation “paths” or schedules, calculating the net profit for each potential application volume. Optimization module 204 then selects the volume that corresponds to economic threshold 506 of the net profit curve 505, effectively discarding scenarios where irrigation would be agronomically beneficial but financially net-negative.

In one embodiment, optimization module 204 is configured to generate an optimized irrigation command. The optimized irrigation command is a structured digital instruction set that includes the calculated profit-maximizing irrigation volume (I*) and the specific timing for the application. Optimization module 204 accounts for “input latency,” such as the time required for water to infiltrate the soil profile, to ensure that the actual moisture state matches the predicted state at the end of the short-term horizon. In one embodiment, optimization module 204 synchronizes the timing of the optimized irrigation command with the utility-dependent cost windows identified in step 303 to ensure physical execution occurs during periods of lowest operational expense.

Furthermore, in some embodiments, the calculation in step 304 incorporates a risk-weighting factor based on the probability of precipitation identified in the short-horizon meteorological forecast. If the forecast indicates a high probability of free water (rain), optimization module 204 may downwardly adjust the profit-maximizing irrigation volume (I*) to prevent over-saturation and nitrogen leaching, thereby further protecting the net profit of the agricultural operation. The resulting optimized irrigation command is then transmitted to irrigation control 205, via communication fabric 109, for physical execution at the field level.

In step 305, irrigation control 205 determines whether the profit-maximizing irrigation volume (I*) exceeds an operational activation threshold value, which may be user-designated. An operational activation threshold value, as used herein, refers to a minimum quantity of water required to justify the operational “start-up” costs of the irrigation infrastructure, such as the energy surge required to prime pumps or the labor involved in manual valve adjustments.

In one embodiment, irrigation control 205 compares the digital value of the profit-maximizing irrigation volume (I*) received from step 304 against a static or dynamic threshold stored in persistent storage 111.

Furthermore, to maintain the closed-loop integrity of the system, irrigation control 205 may implement a verification phase. In this phase, irrigation control 205 monitors hardware-level sensors, such as flow meters or pressure sensors, within the irrigation infrastructure to confirm that the actual volume of water delivered matches the profit-maximizing irrigation volume (I*). This execution data is then logged back into the system to serve as historical context for the next iteration of the data acquisition process in step 301, thereby completing the cyclical optimization process.

In one embodiment, in order to ensure operational efficiency, irrigation control 205 distinguishes between the economic threshold and an operational activation threshold. The operational activation threshold, as used herein, refers to a mechanical or hydraulic floor representing the minimum volume of water below which the energy required to prime the pumping stations or actuate the distribution systems exceeds the value of the moisture gain. While the economic threshold identifies the profit-maximizing limit (I*) based on temporal variability in market conditions, the operational activation threshold serves as a binary gate to prevent “micro-irrigation” events that would cause unnecessary mechanical wear or inefficient energy surges. Consequently, an irrigation event is only initiated when I* is both economically viable and exceeds this minimum operational activation threshold.

If the calculated profit-maximizing irrigation volume (I*) exceeds the operational activation threshold value, then, in step 306, irrigation control 205 generates the necessary hardware-level signals to initiate an irrigation event via an automated irrigation system to deliver the calculated profit-maximizing irrigation volume. An irrigation event, as used herein, refers to the physical application of a specific volume of water to a target area over a scheduled duration as governed by the optimized irrigation command.

In one embodiment, irrigation control 205 initiates the irrigation event via the actuation of the irrigation infrastructure. In one embodiment, irrigation control 205 actuates the irrigation infrastructure by transmitting electronic control signals via communication fabric 109 to field actuators, such as solenoid valves, variable frequency drives (VFDs) on pump motors, or center-pivot drive systems. By translating the optimized digital instruction set into physical mechanical actions, irrigation control 205 ensures that the precisely calculated volume of water is delivered to the field at the optimized time.

If, however, the calculated profit-maximizing irrigation volume (I*) does not exceed the operational activation threshold value, then, in step 307, irrigation control 205 does not initiate an irrigation event. That is, if the calculated profit-maximizing irrigation volume (I*) does not exceed the operational activation threshold value, then irrigation control 205 may automatically defer the irrigation event to a subsequent short-term horizon to avoid inefficient energy expenditure on negligible moisture gains.

In this manner, the principles of the present disclosure optimize agricultural resource allocation by implementing dynamic irrigation scheduling that optimizes agricultural profit by integrating short-horizon meteorological forecasting with economic market data.

Furthermore, the principles of the present disclosure improve the technology or technical field involving precision agriculture.

As discussed above, precision agriculture has emerged as a transformative management strategy that leverages digital technologies to enhance resource use efficiency and agricultural productivity. Historically, precision agriculture has focused on addressing spatial variability (differences in soil characteristics, environmental conditions, and crop performance that occur across various physical locations within a single field) utilizing tools, such as Global Positioning Systems (GPS), geographic information systems (GIS), and variable-rate application (VRA) technologies, to apply inputs, such as seed and fertilizer, more precisely. As the agricultural industry moves toward more data-intensive operations, the focus has expanded from simple spatial precision to “smart” agriculture, which integrates real-time data streams and predictive analytics to manage temporal variability in crop needs. Despite these advancements, a significant gap remains in how critical resources, such as water, are managed, particularly in areas facing extreme scarcity. While existing technologies excel at determining where to apply resources, traditional irrigation management typically relies on “backward-looking” methodologies to determine when or how much to irrigate. These methods often utilize historical climate data or real-time sensor measurements to maintain soil moisture at a specific threshold, regardless of the projected cost of water or the current market value of the crop. Such systems are often referred to as “irrigation triggers,” which focus solely on the agronomic needs of the plant rather than the economic viability of the farming operation. Existing precision farming tools frequently fail to account for the diminishing marginal returns of water application. While increasing irrigation may increase crop yield, there is a point at which the cost of additional water (including pumping and labor costs) exceeds the value of the incremental yield gained. Furthermore, standard models often lack the ability to accurately predict soil moisture levels over a short-term horizon, leading to either over-irrigation, which wastes resources, or under-irrigation, which causes avoidable crop stress. Accordingly, there is a significant and growing need for a predictive decision support system that transcends static irrigation triggers by accounting for both forecasted environmental shifts and the fluctuating economic realities of the agricultural market. Specifically, a need exists for a solution that can identify the precise volume of water required to optimize the financial return of a farming operation, rather than merely satisfying the biological requirements of the crop. Such a system needs to be capable of reconciling the cost of resource application with the projected value of incremental yields to prevent resource waste and maximize net profitability in increasingly water-scarce environments.

Embodiments of the present disclosure improve such technology by acquiring data streams including short-horizon meteorological forecasts, soil-specific constants, and real-time economic market data. Short-horizon meteorological forecasts, as used herein, refer to localized, high-resolution atmospheric predictions, including precipitation probability and temperature, that allow the system to anticipate moisture depletion over a defined upcoming interval. Soil-specific constants, as used herein, refer to the static physical properties of the subject field, such as field capacity and wilting point, which define the mechanical constraints of the soil moisture prediction module. Furthermore, real-time economic market data, as used herein, refers to current crop yield values and utility-dependent irrigation costs, such as electricity or water rates, which are required to evaluate the financial viability of an irrigation event. Future soil moisture conditions over a specified short-term horizon are then predicted, using a machine-learning model, based at least in part on the short-horizon meteorological forecasts and the soil-specific constants. Future soil moisture conditions, as used herein, refer to the projected volumetric water content and hydraulic state of the soil profile at discrete intervals within a predictive window. Furthermore, a short-term horizon, as used herein, refers to a discrete future window, typically spanning 24 to 72 hours, which provides a sufficient lead time for the system to execute proactive irrigation adjustments based on forecasted atmospheric demand. In one embodiment, the future soil moisture conditions are predicted over a specified short-term horizon by inputting the normalized data streams, specifically the atmospheric variables and soil-specific constants, into a trained machine-learning model, such as an extra trees regressor or a Long Short-Term Memory (LSTM) neural network. In one embodiment, the model is configured to map complex non-linear relationships between variables such as solar radiation, wind speed, and precipitation and the resulting depletion rate of water within the soil. An economic threshold for irrigation is then determined based on a marginal return analysis of the real-time economic market data. An economic threshold, as used herein, refers to a dynamic financial limit where the cost of an incremental unit of water is exactly balanced by the value of the projected increase in crop yield derived from that water. Furthermore, a marginal return analysis, as used herein, refers to the iterative calculation of the change in total revenue resulting from an additional unit of irrigation input relative to the change in total variable cost. In one embodiment, the economic threshold for irrigation is determined by calculating the total irrigation cost and the total crop yield value across a range of potential irrigation levels. Furthermore, a profit-maximizing irrigation volume (I*) is calculated for the specified short-term horizon by integrating the predicted future soil moisture conditions with the determined economic threshold. A profit-maximizing irrigation volume, as used herein, refers to the specific quantity of water to be applied to a field that satisfies the dual constraints of maintaining soil moisture above a critical crop-stress threshold while ensuring that the cost of that water does not exceed the marginal increase in projected yield value. In one embodiment, the profit-maximizing irrigation volume (I*) is calculated for the specified short-term horizon by performing a multi-objective optimization that filters the generated conditional soil moisture forecasts against the identified economic threshold. An irrigation event is then automatically initiated via an automated irrigation system to deliver the calculated profit-maximizing irrigation volume in response to the profit-maximizing irrigation volume exceeding an operational activation threshold value. An irrigation event, as used herein, refers to the physical application of a specific volume of water to a target area over a scheduled duration as governed by the optimized irrigation command. An operational activation threshold value, as used herein, refers to a minimum quantity of water required to justify the operational “start-up” costs of the irrigation infrastructure, such as the energy surge required to prime pumps or the labor involved in manual valve adjustments. In one embodiment, the irrigation event is initiated via the actuation of the irrigation infrastructure. In one embodiment, the irrigation infrastructure is actuated by transmitting electronic control signals via a communication fabric to field actuators, such as solenoid valves, variable frequency drives (VFDs) on pump motors, or center-pivot drive systems. By translating the optimized digital instruction set into physical mechanical actions, it is ensured that the precisely calculated volume of water is delivered to the field at the optimized time. In this manner, agricultural resource allocation is optimized by implementing dynamic irrigation scheduling that optimizes agricultural profit by integrating short-horizon meteorological forecasting with economic market data. Furthermore, in this manner, there is an improvement in the technical field involving precision agriculture.

The technical solution provided by the present disclosure cannot be performed in the human mind or by a human using a pen and paper. That is, the technical solution provided by the present disclosure could not be accomplished in the human mind or by a human using a pen and paper in any reasonable amount of time and with any reasonable expectation of accuracy without the use of a computer.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

1. A computer-implemented method for dynamic irrigation scheduling to optimize agricultural profit, the method comprising:
acquiring a plurality of data streams comprising short-horizon meteorological forecasts, soil-specific constants, and real-time economic market data;
predicting, using a machine-learning model, future soil moisture conditions over a specified short-term horizon based at least in part on said short-horizon meteorological forecasts and said soil-specific constants;
determining an economic threshold for irrigation based on a marginal return analysis of said real-time economic market data, wherein said real-time economic market data comprises a current market value of a crop and a projected cost of water application;
calculating a profit-maximizing irrigation volume for said specified short-term horizon by integrating said predicted future soil moisture conditions with said determined economic threshold; and
automatically initiating an irrigation event via an automated irrigation system to deliver said calculated profit-maximizing irrigation volume in response to said profit-maximizing irrigation volume exceeding an operational activation threshold value.

2. The method as recited in claim 1, wherein said machine-learning model utilizes an extra trees regressor to predict said future soil moisture conditions.

3. The method as recited in claim 1, wherein said machine-learning model utilizes a Long Short-Term Memory (LSTM) neural network to process temporal variability in said short-horizon meteorological forecasts.

4. The method as recited in claim 1, wherein said specified short-term horizon spans 24 to 72 hours.

5. The method as recited in claim 1, wherein said real-time economic market data is retrieved from a United States Department of Agriculture (USDA) National Agricultural Statistics Service (NASS) database.

6. The method as recited in claim 1, wherein said determining of said economic threshold further comprises calculating diminishing marginal returns of yield relative to an incremental water application.

7. The method as recited in claim 1 further comprising:
retrieving real-time ground-truth telemetry from an IoT sensor set;
calculating an error between said predicted future soil moisture conditions and said real-time ground-truth telemetry; and
recalibrating weights of said machine-learning model based on said calculated error to minimize model drift.

8. A computer program product for dynamic irrigation scheduling to optimize agricultural profit, the computer program product comprising one or more computer readable storage mediums having program code embodied therewith, the program code comprising programming instructions for:
acquiring a plurality of data streams comprising short-horizon meteorological forecasts, soil-specific constants, and real-time economic market data;
predicting, using a machine-learning model, future soil moisture conditions over a specified short-term horizon based at least in part on said short-horizon meteorological forecasts and said soil-specific constants;
determining an economic threshold for irrigation based on a marginal return analysis of said real-time economic market data, wherein said real-time economic market data comprises a current market value of a crop and a projected cost of water application;
calculating a profit-maximizing irrigation volume for said specified short-term horizon by integrating said predicted future soil moisture conditions with said determined economic threshold; and
automatically initiating an irrigation event via an automated irrigation system to deliver said calculated profit-maximizing irrigation volume in response to said profit-maximizing irrigation volume exceeding an operational activation threshold value.

9. The computer program product as recited in claim 8, wherein said machine-learning model utilizes an extra trees regressor to predict said future soil moisture conditions.

10. The computer program product as recited in claim 8, wherein said machine-learning model utilizes a Long Short-Term Memory (LSTM) neural network to process temporal variability in said short-horizon meteorological forecasts.

11. The computer program product as recited in claim 8, wherein said specified short-term horizon spans 24 to 72 hours.

12. The computer program product as recited in claim 8, wherein said real-time economic market data is retrieved from a United States Department of Agriculture (USDA) National Agricultural Statistics Service (NASS) database.

13. The computer program product as recited in claim 8, wherein said determining of said economic threshold further comprises calculating diminishing marginal returns of yield relative to an incremental water application.

14. The computer program product as recited in claim 8, wherein the program code further comprises the programming instructions for:
retrieving real-time ground-truth telemetry from an IoT sensor set;
calculating an error between said predicted future soil moisture conditions and said real-time ground-truth telemetry; and
recalibrating weights of said machine-learning model based on said calculated error to minimize model drift.

15. A system, comprising:
a memory for storing a computer program for dynamic irrigation scheduling to optimize agricultural profit; and
a processor connected to the memory, wherein the processor is configured to execute program instructions of the computer program comprising:
acquiring a plurality of data streams comprising short-horizon meteorological forecasts, soil-specific constants, and real-time economic market data;
predicting, using a machine-learning model, future soil moisture conditions over a specified short-term horizon based at least in part on said short-horizon meteorological forecasts and said soil-specific constants;
determining an economic threshold for irrigation based on a marginal return analysis of said real-time economic market data, wherein said real-time economic market data comprises a current market value of a crop and a projected cost of water application;
calculating a profit-maximizing irrigation volume for said specified short-term horizon by integrating said predicted future soil moisture conditions with said determined economic threshold; and
automatically initiating an irrigation event via an automated irrigation system to deliver said calculated profit-maximizing irrigation volume in response to said profit-maximizing irrigation volume exceeding an operational activation threshold value.

16. The system as recited in claim 15, wherein said machine-learning model utilizes an extra trees regressor to predict said future soil moisture conditions.

17. The system as recited in claim 15, wherein said machine-learning model utilizes a Long Short-Term Memory (LSTM) neural network to process temporal variability in said short-horizon meteorological forecasts.

18. The system as recited in claim 15, wherein said specified short-term horizon spans 24 to 72 hours.

19. The system as recited in claim 15, wherein said real-time economic market data is retrieved from a United States Department of Agriculture (USDA) National Agricultural Statistics Service (NASS) database.

20. The system as recited in claim 15, wherein said determining of said economic threshold further comprises calculating diminishing marginal returns of yield relative to an incremental water application.
